(19) United States
(12) Patent Application Publication
(10) Pub. No.: US 2006/0104066 A1
(43) Pub. Date: May 18, 2006

(54) Pendant light fixture

(75) Inventors: Samuel Cini, Brampton (CA); David Doyle, Georgetown (CA)

Correspondence Address: PEARNE & GORDON LLP, 1801 EAST 9TH STREET, SUITE 1200, CLEVELAND, OH, 44114-3108, US

(73) Assignee: Signage Systems, a division of 865331 Ontario Limited of Canada, Mississauga, CA (US)

(21) Appl. No.: 10/988,146

(22) Filed: Nov. 12, 2004

(51) Int. Cl. F21V 29/00

(52) U.S. Cl. 362/373

(57) ABSTRACT

A light fixture for location adjacent to a surface. The fixture includes a framework that permits flow therethrough. The framework has a plurality of sides. The fixture includes a plurality of light devices extending along the plurality of sides of the framework. Each pair of adjacent sides meet at a corner. The fixture includes a plurality of cove pieces extending adjacent to the plurality of light devices along the plurality of sides of the framework. Each cove piece terminates in the vicinity of associated corners of the framework. The fixture includes a plurality of corner pieces located at the corners of the framework. Each corner piece overlaps at least a portion of each of two cove pieces terminating in the vicinity of associated corner of the framework.

### FIELD OF THE INVENTION

The present invention is directed in general to light fixtures that are located at a surface, such as a ceiling, wall or floor of a building or other structure. In one aspect, the present invention is directed to a fixture that permits air flow.

### BACKGROUND OF THE INVENTION

Often, it is desirable to have a light fixture at a ceiling, wall, or even a floor of a building or other structure. Often, there is a need for ventilation (e.g., air flow) within the same room. Ventilating light fixtures are known. Such a light fixture is often used with an office or bathroom environment to remove moisture-laden air. However, such light fixtures are often of a relative small size and are pre-manufactured to the specific size. Also, Typically, a contained lighting device (e.g., one or more light bulbs) is generally centrally located (i.e., not at the outer periphery).

### SUMMARY OF THE INVENTION

In accordance with one aspect, the present invention provides a light fixture for location adjacent to a surface. The light fixture includes a framework that permits flow therethrough. The framework has a plurality of sides. The fixture includes a plurality of light devices extending along the plurality of sides of the framework. Each pair of adjacent sides meets at a corner. The fixture includes a plurality of cove pieces extending adjacent to the plurality of light devices along the plurality of sides of the framework. Each cove piece terminates in the vicinity of associated corners of the framework. The fixture includes a plurality of corner pieces located at the corners of the framework. Each corner piece overlaps at least a portion of each of two cove pieces terminating in the vicinity of an associated corner of the framework.

### BRIEF DESCRIPTION OF THE DRAWINGS

The foregoing and other features and advantages of the present invention will become apparent to those skilled in the art to which the present invention relates upon reading the following description with reference to the accompanying drawing, in which:

FIG. 1 is an upwardly looking perspective view of an example of a light fixture and located on a surface, the shown example surface is a ceiling;

FIG. 2 is a downwardly looking perspective view of the example fixture of FIG. 1 disjoint from the surface;

FIG. 3 is a schematic diagram showing an example of an arrangement that includes a fixture, an air treatment component, and components associated with input for control; and

FIG. 4 is schematic diagram showing an example of air flow within a system that contains two fixtures in accordance with the present invention.

### DETAILED DESCRIPTION OF AN EXAMPLE EMBODIMENT

Certain terminology is used herein for convenience only and is not to be taken as a limitation on the present invention. Further, in the drawings, the same reference numerals are employed for designating the same elements, and in order to clearly and concisely illustrate the present invention, certain features may be shown in somewhat schematic form.

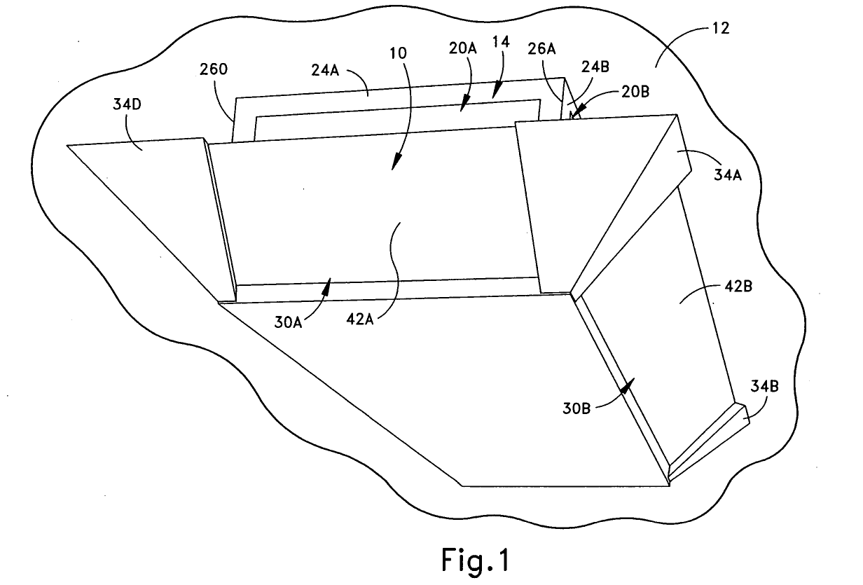

An example of a pendant light fixture 10 in accordance with the present invention is shown in FIG. 1. The example fixture 10 can be considered to be an island that extends downward from (e.g., is adjacent to) a surface that is a ceiling 12 of a room within a building. It is to be appreciated that while the shown example is adjacent to a building ceiling, it is contemplated that the inventive aspects of the present invention may be applied to other surfaces, such as walls, floors, and roofs, and that the surface may be located within any other structure type, such as portable buildings, vehicles, and trailers. Still further, it is to be appreciated that the fixture 10 and/or the surface and the connection between the fixture and the surface may be permanent or temporary. Even further, it is to be appreciated that the connection between the fixture 10 and the surface may take any form (e.g., direct connection, suspension via wires or the like, extending from an interposed pedestal) such that the fixture is adjacent. Also, it is to be appreciated that while the shown example is a pendant fixture, it is contemplated that the inventive aspects of the present invention may be applied to a non-light fixture (i.e., no light source(s) therein or otherwise not providing/conveying light).

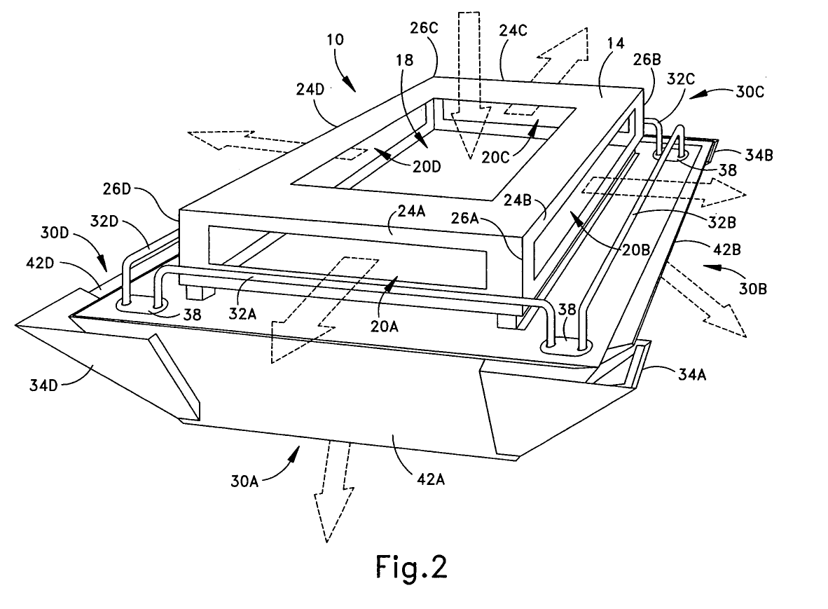

The fixture 10 has a framework 14 that can be secured to the ceiling 12 for supporting the fixture therefrom. It is to be noted that the framework 14 (FIG. 2) may be made of any material or combination of materials (e.g., plastic, wood or metal). Also, it is to be appreciated that the framework 14 may have a variety of construction configurations. As such, the framework 14 is somewhat schematically shown. Also, any suitable fastener/fastening arrangement (e.g., mounting hardware, screws, etc.) may be used to secure the framework 14 to the ceiling 12.

It is to be noted that in the shown example, openings or spaces 18 and 20A-20D are provided through the framework 14. Such openings 18 and 20A-20D permit flow (e.g., air flow) through the framework 14. In the shown example, the framework 14 has a central, upper opening 18 at the upper portion of the framework that engages the ceiling 12 (FIG. 1). It is to be appreciated that a corresponding flow passage (not visible in the Figures) through the ceiling 12 will face the upper opening 18 in the framework 14. The interior of the framework 14 is generally hollow. Also, at each of the four sides of the example structure, a lateral opening (e.g., 20A) extends from the interior to the exterior of the framework 14. Thus, flow can proceed through the upper opening 18, through the framework interior, and through any of the lateral openings 20A-20D. Of course, flow may proceed in the opposite direction. It is to be appreciated that the air flow need not proceed through the ceiling. As such, the air flow could merely flow from one side to another. The direction of flow may depend upon force being applied to cause the flow. For example, a fan (not shown, e.g., either for in-flow or out-flow) may be provided to cause flow. The fan may be located in the ceiling 12 (FIG. 1), within the framework, or elsewhere. Also, other devices and/or methods (e.g., convection flow) may be utilized.

It is to be noted that the shown example has flow that proceeds into the upper opening 18 and out from the lateral openings 20A as indicated by the dashed arrowheads. Such a flow may be indicative of a flow of fresh ventilation air. However, as mentioned above, the flow may be in the opposite direction. Such an opposite direction flow may be used to exhaust unwanted air or fumes, such as stale air or moisture laden air (e.g., in a bathroom environment).

Also, the shown example indicates flow (i.e., via dashed arrowheads) from other locations of the fixture 10. In the shown example, the flow is from a lower portion of the fixture 10. As such, it is to be understood that the fixture 10 may have structure to permit such flow. Along the lines of flow, it is to be appreciated that the fixture 10 may be designed primarily for ventilation. As such, the light or non-light aspect of the present invention would be ancillary.

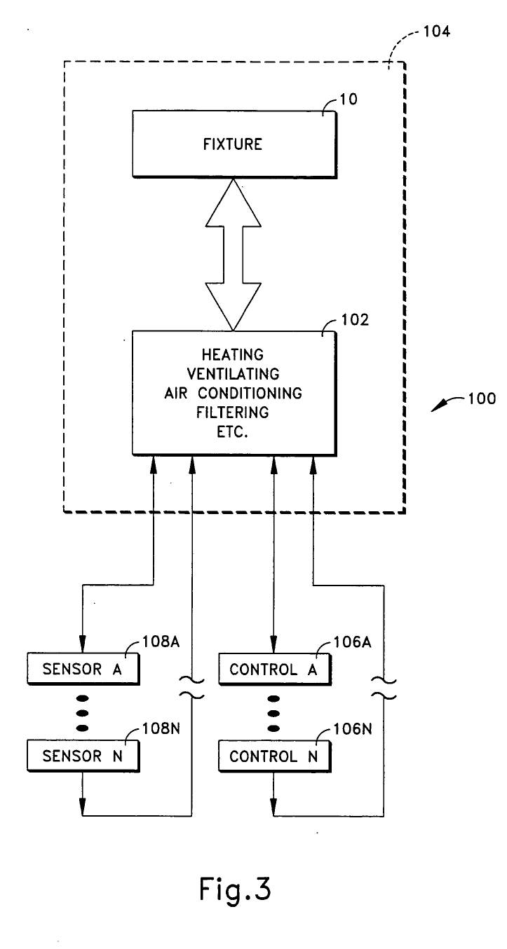

With regard to flow, it is to be appreciated that the fixture 10 may be part of a system. An example of such a system 100 is shown in FIG. 3. The shown example system 100 includes an air treatment device 102. The air treatment device 102 may provide for one or more treatments to the air flow. Examples of such air treatments are heating, ventilating, air conditioning, filtering, air purifying, etc. It is to be appreciated that the air treatment device 102 may be integral with the fixture 10 or separate from the fixture. This flexibility is indicated by the phantom line that encloses the fixture and the air treatment device as an arrangement 104.

Turning to the flow for a moment, as mentioned above, the flow may be associated with an air filter, an air purifier, or other air treatment means. As one example of a non-filter air purifier, a UV lamp purification system may be utilized. In connection with aspects such as air filtering, purifying, or the like it is to be appreciated that the flow may be a recirculating flow. Further concerning flow, it is to be appreciated that the one or more dampers and/or one or more fans may be provided, associated, or otherwise utilized to direct/cause the flow within the device 102. Such damper and/or fan control may be provided via one or more wall mounted control units and/or one or more handheld units (e.g., control A-Control N, with “N” representing any number) 106A-106N. Also, one or more sensors (e.g., sensor A-sensor N, with “N” representing any number) 108A-108N may be provided and utilized with the control structure. Such sensors may be integral with one or more of the components and/or such sensors may be remotely located from the components. In general, it is to be appreciated that the controls, sensors, etc. may be at any location.

Also, it to be appreciated that the fixture 10 can provide a variety of additional and/or different heating, ventilating, and air conditioning (HVAC) functions, and also other functions, such as filtering mentioned above. In general, such functions can be referred to as air treatment functions as mentioned above. For example, the fixture 10 may include a heating device to heat the airflow. As another example, the fixture 10 may include an air-conditioning device to cool the airflow. This is to say that the temperature increase or decrease imposed upon the airflow occurs within the fixture 10. Of course, it is to be appreciated that treated (e.g., filtered, heated, and/or cooled) air, which has been treated (e.g., filtered, heated, and/or cooled) elsewhere can certainly be directed through the fixture 10. Turning to the issue of the structure associated with the air treatment (e.g., filtering, heating, and/or cooling), it is to be appreciated that a variety of structures may be utilized. For example, heating may be provided via various types of electric elements or a heat pump circuit (e.g., a condenser). Also as example, cooling may be provided by evaporator coils (e.g., of an air-conditioning circuit or a heat pump) or an electric circuit. With regard to air treatment (e.g., HVAC) functions, it is to be appreciated that the flow may be in the form of recycled air flow, including recycled air flow from another area that has a different atmospheric condition (e.g., hotter or cooler).

It is to be appreciated that some or all of the structure associated with the air treatment (e.g., filtering, ventilating, heating, and/or cooling) may be located within the pendant fixture 10. In particular, it is to be appreciated that an entirely contained device, such as an air-conditioning device, may be located within the pendant fixture 10.

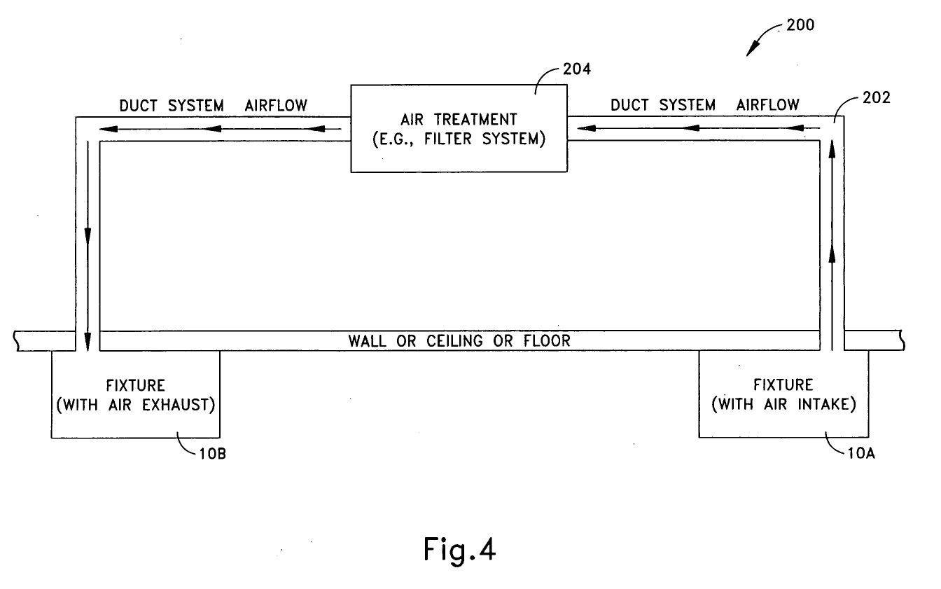

Turning to the issue of air flow that is treated elsewhere (i.e., outside of a fixture), FIG. 4 provides one example system 200 for such remote (i.e., remote from a fixture) treatment. Within the shown example system, two fixtures 10A and 10B are utilized. One fixture 10A provides for air intake and the other fixture 10B provides for air exhaust. A duct sustem 202, provides a conduit for movement of air from the first fixture 10A, through an air treatment device (e.g., a filter system) 204, and to the second fixture 10B.

It is to be appreciated that some or all of the components that are possibly associated with the pendant fixture (e.g., within the pendant, adjacent the pendant, or otherwise providing air flow through the pendant) may be powered by any suitable energy source. For example, the energy may be provided by something that can be considered to be conventional or unconventional, such as land-line electrical power, gas, hydro, fuel cells, solar, or even wind. However, it is to be appreciated that any energy source may be used. The energy source may be a single-use energy source or may be a renewable energy source. Similar to the components being powered, the energy source may be contained within the pendant fixture, or may have some part within the pendant fixture.

Turning back to the framework 14, as can be appreciated upon viewing the example shown in the Figures, the example framework has a plurality (e.g., four) surfaces 24A-24D, with each adjacent pair of surfaces intersecting at an exterior corner (e.g., 26A). As such, the framework 14 has four exterior corners 26A-26D. It is to be appreciated that a different number of surfaces, and accordingly a different number of exterior corners, may be provided within the scope of the present invention. To be more specific, it is to be appreciated that the pendant fixture may be of any polygonal shape with any number of corners, and the corners need not be right-angle corners. Further, the pendant fixture may include some curved portions or may be entirely provided with curved portions.

The example fixture 10 has four segments 30A-30D. Each segment (e.g., 30A) extends along a respective surface (e.g., 24A) of the framework 14. Each segment (e.g., 30A) has a respective light device (e.g., 32A) associated therewith. It is to be noted that the segments 30A-30D may have a variety of structure. As such, the segments 30A-30D are shown in a somewhat schematic form. Also, the example fixture light 10 has four corner pieces (only three, 34A, 34B, and 34D, are visible). Each corner piece (e.g., 34A) extends over ends of adjacent segments (e.g., 30A and 30B).

In one example, it is to be noted that the ends of the adjacent segments (e.g., 30A and 30B) need not engage each other. In other words, a space exists between the segments (e.g., 30A and 30B). The possible spacing is referred to herein as a non-fitted manner. However, it is possible that the segments (e.g., 30A and 30B) engage. Regardless of the fitting of the adjacent segments (e.g., 30A and 30B), the respective corner piece (e.g., 34A) hides the junction from view. As such, each corner piece (e.g., 34A) is configured to overlap the ends of a respective pair of segments (e.g., 30A and 30B) and obscure from view the ends of the first and second segments and any spacing. In other words, the corner piece (e.g., 34A) covers over the non-fitting manner of the segments (e.g., 30A and 30B). An example of segments that are covered at the ends by a corner piece is disclosed in U.S. patent application Ser. No. 10/833,434, entitled “LIGHT MOUNTING FIXTURE FOR INTERSECTING SURFACES OF VARIABLE LENGTH AND METHOD FOR INSTALLING SAME,” which is incorporated herein by reference. It should be noted that the pendant fixture of the present invention may have an appearance that is matched to any appearance within which it is to be utilized. In particular, the appearance of the pendant fixture may be matched to appearance of the “LIGHT MOUNTING FIXTURE . . . ” of U.S. patent application Ser. No. 10/833,434.

The segments 30A-30D have some amount of similarity to each other. As such, only one segment (i.e., 30A) is described in detail with an understanding the description is generally applicable to the other segments. The segment 30A is attached to the framework 14 in any suitable manner. As such, the segment 30A has any suitable structure to accomplish the attaching function. It is to be noted that the structure within the segment 30A for the purpose of attaching is somewhat dependent upon the structure of the framework 14. In one example, the structure for attaching the segment 30A to the framework 14 includes a plurality of attachment devices. It is to be appreciated that such attachment devices may have any suitable configuration, construction, etc. In one example, the attachment devices are brackets. Each bracket is secured to the surface 24A via a fastener (e.g., a screw or the like).

Turning for the moment to the light device (e.g., 32A) associated with each segment, it is to be appreciated that any suitable light device may be used. In short, it is to be appreciated that the light device (e.g., 32A) may have any structure, configuration, etc. For example, the light device (e.g., 32A) may include one or more light tubes, electric connector supports, reflectors, suitable electrical connections, etc. Also, the light device (e.g., 32A) may be of any type (e.g., fluorescent, cold cathode, neon, light-emitting diode, fiber optic, etc.). In the shown example, the light device (e.g., 32A) includes a tube-type light member that is engaged at its ends into receptacle sockets 38. The end portions of the member extend generally perpendicular to a major extent of the member to engage the sockets 38. Although the example embodiment is presented with the light device so placed, it is to be appreciated that the light device may be otherwise located and the light is provided a remote location and brought or directed to the desired location for emanation for illumination.

In the shown example, only a single light device (e.g., 32A) is shown for each segment (i.e., a total of four for the four segments). It is to be appreciated that multiple light devices may be located each segment, and the number of light devices may be related to the overall length of the segment. Still further, an adjustable light device may be employed as the light device or one of plural light devices. An example of an adjustable light device is disclosed in U.S. patent application Ser. No. 10/300,489, entitled “ADJUSTABLE-LENGTH LIGHT FIXTURE AND METHOD FOR INSTALLING SAME,” which is incorporated herein by reference. In short summary, within the example adjustable light device light tubes overlap each other, and yet are moveable relative to each other to change the overall length.

Turning again to the overall segment (e.g., 30A), a cove piece (e.g., 42A) of the segment is mounted to be the major exteriorly viewed portion of the segment. In one example, the cove piece 42A is mounted onto the attachment devices. Such mounting of the cove piece 42A is accomplished via any suitable means such as inter-fitting parts on the attachment devices and the cove piece (e.g., snap-fit), mechanical fasteners, adhesive, or the like. In the shown example, the cove piece 42A is a unitary member. However, it is contemplated that the cove piece 42A could include plural members.

The cove piece 42A serves one or more functions. For example, the cove piece 42A can obscure the direct viewing of the other components of the first segment 30A. In other words, the cove piece 42A could prevent an observer from normal, direct viewing of the attachment devices, the light device 32A, etc. Also, the cove piece 42A could provide protection from damage, elements, etc.

In the shown example, the cove piece 42A extends generally up from the bottom at an outward angle. As such, the top of the cove piece 42A is the outermost portion. For such a configuration, light proceeding from the light device 32A is blocked from proceeding downward and is directed generally upward. However, it is contemplated that the cove piece 42A could have a different functional configuration. For example, the cove piece 42A could be open at a lower extent and/or the cove piece could extend to point above the first segment. Light would be permitted to proceed accordingly. As another possibility, the light from the light device 32A could proceed from any porous or open area of the pendant fixture. Still further, any portion of the pendant fixture may be translucent, or otherwise permit passage of some portion of light.

Also, it is to be appreciated that the cove piece 42A could be constructed of various materials. In one example, the cove piece 42A is made of aluminum. However, the cove piece 42A could be made of wood, plastic, etc. With the regard to the use of plastic or similar product, it is contemplated that the plastic or similar product may have a level of translucence and/or contain perforations. This would permit a lower level of diffuse light to proceed through the cove piece 42A.

Each corner piece (e.g., 34A) typically has a complementary construction, configuration, etc. to the adjacent cove pieces (e.g., 42A and 42B). Thus, the combination of the cove pieces and the corner pieces provides for an aesthetically pleasing appearance. This in itself is yet another function of the fixture 10. It is to be appreciated that the aesthetic aspects of the fixture 10 can be varied.

It is to be appreciated that the fixture 10 need not be of a predetermined size (e.g., the size can be customized). It is to be clearly understood that the pendant fixture 10 may be of any size. The ability to customize the size is due, in part, to the ability to have the segments 30A-30D, and specifically the cove pieces 42A-42D, be of any desired size. The frame 14 would of course be of appropriate size. The ability to have the cove pieces of any size, and yet have the ends covered by the corner pieces 42A-42D permits some amount of non-perfect mating of to cove pieces at the location of a corner without detraction of aesthetics. Also, length of the light devices 32A-32D can be varied to achieve desired lighting effect.

From the above description of the invention, those skilled in the art will perceive improvements, changes and modifications. For example, the fixture can be provided, cooperate, and/or work in combination with adjacent fixtures, new objects, and/or existing objects. A sample, and not exhaustive, list of objects includes clocks, mirrors, coat racks, doors, shelves, ovens, monitors/televisions, decorations, windows, pictures, candle chandeliers, stereos, printing devices, computer devices, garbage units, curtain blinds, partitions or newly invented items Such improvements, changes and modifications within the skill of the art are intended to be covered by the appended claims.

What is claimed:

1. A light fixture for location adjacent to a surface, the light fixture including:
a framework that permits flow therethrough, the framework having a plurality of sides;
a plurality of light devices extending along the plurality of sides of the framework, each pair of adjacent sides meeting at a corner;
a plurality of cove pieces extending adjacent to the plurality of light devices along the plurality of sides of the framework, each cove piece terminating in the vicinity of associated corners of the framework; and
a plurality of corner pieces located at the corners of the framework, each corner piece overlapping a least a portion of each of two cove pieces terminating in the vicinity of the associated corner of the framework.

2. A light fixture as set forth in claim 1, wherein the framework includes an upper opening at an upper portion of the framework, and a plurality of side openings in the sides of the framework.

3. A light fixture as set forth in claim 1, wherein the surface is a ceiling, and the light the framework includes an upper opening at an upper portion of the framework, and a plurality of side openings in the sides of the framework.

4. A light fixture as set forth in claim 1, wherein the ends of at least one pair of two cove pieces that terminate in the vicinity of the associated corner have an aesthetically unpleasing space therebetween.

5. A light fixture as set forth in claim 4, wherein the corner piece associated with the two cove pieces that have the space there between covers the space.

6. A light fixture as set forth in claim 1, including structure to provide at least one of heating, ventilating, air conditioning, and filtering functions.

7. A light fixture as set forth in claim 6, including means for controlling the HVAC function from a location remote from the light fixture.
